(19) United States
(12) Patent Application Publication
(10) Pub. No.: US 2004/0251357 A1
(43) Pub. Date: Dec. 16, 2004

(54) Apparatus for cracking a nut

(76) Inventor: Karl-Heinz Lenzkes, Schalksmuhle (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/797,306

(22) Filed: Mar. 10, 2004

(30) Foreign Application Priority Data
Mar. 10, 2003 (DE) 203 03 765.0
Feb. 17, 2004 (EP) 04 003 462.1

(51) Int. Cl. B29B 13/00

(52) U.S. Cl. 241/262

(57) ABSTRACT

The present invention relates to a nut cracker (100). The nut cracker (100) includes a stationary die (1) and a movable die (11). The movable die (11) is designed as a falling weight. The falling weight is designed and arranged to fall down towards the stationary die (1) due to gravity to crack the nut.

### CROSS REFERENCE TO RELATED APPLICATIONS

This application claims priority to co-pending German Gebrauchsmuster No. 203 03 765.0 entitled “Vorrichtung zum Knacken einer Nuss”, filed Mar. 10, 2003 and European Patent Application No. 04 003 462.1 entitled “Vorrichtung zum Knacken einer Nuss”, filed Feb. 17, 2004.

### FIELD OF THE INVENTION

The present invention generally relates to an apparatus for cracking a nut. It is known that nuts of any kind, for example walnuts, Brazil nuts, hazelnuts and the like have a comparatively hard shell and a soft core to be eaten. To reach the core, the respective nut has to be cracked. It is desired to destroy the shell and to remove the pieces of the shell without damaging the core.

### BACKGROUND OF THE INVENTION

Apparatuses for cracking nuts which are designed in a form similar to pliers are generally known in the art. These pliers include two handles being arranged to be pivotable with respect to one another. Each of the movable handles is connected to a movable die such that the nut may be placed between and cracked by the dies. Due to the fact that different nuts, especially different kinds of nuts, have different sizes, it is not easy to crack the nuts without damaging the core. The known nut crackers in the form of pliers only have one end position in which the handles are located at the smallest distance with respect to one another. This position is defined by a stop element. Consequently, the maximum path of the dies with respect to one another is also limited. This maximum path can only be optimal for one certain kind of nuts. Consequently, the use of such pliers often results in the core being at least partly damaged. In case the dies have a wedge-like shape, there is the possibility of placing the nut at a certain position of the pliers to adapt the respective maximum path to the diameter of the nut. However, this requires certain skills by the user.

Other nut crackers being based on the principle of a screw and of a screwing spindle, respectively, are also known in the art. These nut crackers include two movable dies being movable with respect to one another. One of the dies is connected to a screwing spindle such that it approaches the other die due to a rotational movement. These known nut crackers have the advantage of the rotational movement directly terminating the stroke of the respective rotationally movable die such that it is easier to crack nuts of different sizes without damaging the core. However, the rotational movement often requires substantial forces, especially for cracking hard nuts. Such known nut crackers are often made of wood such that there is the danger of the thread convolution of the wooden screw spindle being damaged when comparatively great forces occur.

### SUMMARY OF THE INVENTION

The present invention relates to an apparatus for cracking a nut. The apparatus includes a stationary die and a movable die. The movable die is designed as a falling weight. The falling weight is designed and arranged to fall down towards the stationary die due to gravity to crack the nut.

The present invention also relates to nut cracker including a fall bar, a stand and movable cracking element. The stand includes an approximately horizontal supporting surface. The supporting surface is designed and arranged to hold a nut. The fall bar has an approximately vertical axis. The fall bar is connected to the stand. The movable cracking element is designed and arranged to be movable with respect to the fall bar due to gravity in a way that the movable cracking element falls down towards the supporting surface to crack a nut.

With the novel apparatus for cracking nuts, it is possible to sensitively crack nuts of different sizes and/or nuts of different kinds without problem. The danger of the core being damaged is substantially reduced.

The novel apparatus for cracking nuts includes two dies being movable with respect to one another in a way that one of the dies is designed as a stationary element and the other die is designed as a falling weight to fall down on the nut to crack the nut. The mass and the falling height of the movable die are chosen to crack the respective nut.

The novel apparatus and nut cracker is based on the use of gravity. It includes a falling weight having a determined mass. Due to the use of different falling heights, the nut may be sensitively cracked. The shell of the nut is easily cracked without damaging the core by using sudden forces which only act upon the shell of the nut for a comparatively short period of time. The user may easily and sensitively adapt the impulse resulting from the falling weight (which falls down on the nut) to the kind of the nut, to the diameter of the nut and to the hardness of the nut, respectively. When a first falling test conducted by the user does not result in the nut being correctly cracked or the core being damaged, the user may vary the falling height to achieve the desired result.

It is especially preferred if the movable falling weight is guided in an approximately vertical direction. In this way, the maximum acceleration of the weight due to gravity is attained. Additionally, it is ensured that the die serving as the falling weight exactly hits the predetermined part of the nut. It is possible to choose different ways of guiding the die in a vertical direction.

It is advantageous if the movable die includes an opening and the fall bar is designed and arranged to protrude through the opening. The opening is designed to be circumferentially open to both sides, and it is centrally arranged at the falling weight such that the falling weight in the relative position in which it contacts the nut partly or complete exits from the falling bar. The falling weight has a determined relative position when hitting the nut.

Another possibility of realizing the vertical guiding effect of the falling weight is the use of a plurality of two or more fall bars and a respective number of two or more openings being located at the falling weight. The openings may also be designed as circumferentially opened channels. In this embodiment of the novel apparatus, the falling weight in its middle portion does not include openings. The portion of the falling weight which contacts the nut may have a concave or a convex design.

Preferably, the two dies at their surfaces facing one another include impressions. These impressions may have different radiuses. It is preferred if the falling weight has the smaller radius. The design of convex impressions has the effect of components of the cracked shell of the nut being collected in the impressions, and only some broken parts leave the region of the apparatus.

In a special embodiment of the novel apparatus, the fall bar may have the shape of a “U” of which one leg is fixedly connected to the stationary die, and the other leg protrudes through the die serving as the falling weight. This leg ends above the impression of the stationary die. In another embodiment of the apparatus, there are two fall bars between which the falling weight is guided in channels. The lower ends of the fall bars are fixedly connected to the stationary die serving as the stand of the apparatus such that the falling weight is guided along the entire falling path in the same way. Both embodiments result in attractive designs in which the structure may be chosen such that the die serving as the falling weight is not released from the fall bar. In this way, the falling weight is captively connected to the fall bar. Also, due to the freely ending leg or due to the arrangement of two fall bars, there still is enough room to place nuts of different sizes in the stationary die.

The die serving as the falling weight may have an approximately spherical shape. At its bottom side, it may include an impression. However, it is also possible to choose a convex design. The opening extends through the spherical die in a vertical direction. In case there is a plurality of impressions or channels, they are preferably arranged in an eccentric way with respect to the axis.

To simplify use of the fall bar with different kinds of nut, different sizes of nuts or nuts having shells with different hardness, the apparatus may include associated marks indicating different falling heights. For example, a hazelnut to be cracked usually requires a smaller falling height than a Brazil nut or a walnut. It is to be understood that each kind of nut also includes nuts of different sizes and of different hardness. When the first cracking test does not result in the desired outcome, the falling height may be increased to increase the force, and to attain the desired result.

Usually, the movable die serving as the falling weight is designed as a rotationally symmetric body. The respective mass is concentrated in the die. It is preferred to design the falling weight as a massive body made of metal including one or more impressions being directed in a vertical direction.

It is possible to arrange a splash guard element in the region of the dies. The splash guard element serves to prevent parts of the shell of the nut from leaving the apparatus when the nut is cracked. The splash guard element may be arranged at and connected to, respectively, the movable die or the stationary die. A third possibility is to loosely arrange the splash guard element between the dies. The splash guard element preferably is designed to be at least partly resilient to be capable of allowing for different falling heights and different approaches of the dies, respectively. For example, the splash guard element may include a cylindrical spring or a conical spring, it may be made of a form body of a resilient plastic foam and the like. The splash guard element may also include one or more rims being located at the dies, the rims partly overlapping in a telescopic way.

Preferably, the stationary die is designed as a stand being connected to the fall bar having an inverted U-shaped design.

Preferably, the stationary die has a greater mass than die movable die. In this way, the novel nut cracker is stable and easy to be used. In addition, it does not only fulfill the technical requirements, but it also has an attractive design.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a view of a first exemplary embodiment of the novel apparatus for cracking a nut.

FIG. 2 is a view of a second exemplary embodiment of the novel apparatus for cracking a nut.

FIG. 3 is a view of a third exemplary embodiment of the novel apparatus for cracking a nut.

FIG. 4 is a view of a fourth exemplary embodiment of the novel apparatus for cracking a nut.

FIG. 5 is a view of a fifth exemplary embodiment of the novel apparatus for cracking a nut.

### DETAILED DESCRIPTION

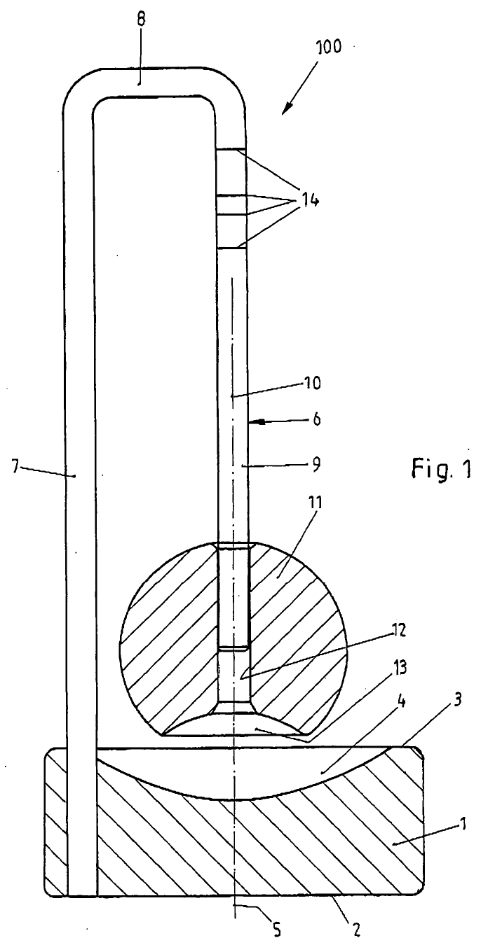

Referring now in greater detail to the drawings, FIG. 1 illustrates a first exemplary embodiment of the novel apparatus 100 for cracking nuts. The apparatus 100 includes a first die 1 which as well serves as a stand for the entire apparatus 100. The stationary die 1 at its bottom side 2 is designed to be flat such that the apparatus 100 may be placed on a table or a different support. The die 1 at its upper side 3 includes a concave impression 4. The die 1 may be designed as a rotationally symmetric body about an axis 5. It is made of a material having a comparatively great mass, for example metal, which results in increased stability of the apparatus 100.

The apparatus 100 further includes a fall bar 6 being designed as a U-shaped wire element. The fall bar 6 further includes a first leg 7 being fixedly connected to the die 1. The first leg 7 is connected to a horizontal leg 8 being connected to a second vertical leg 9 of the fall bar 6. The second leg 9 has an axis 10 being aligned to the axis 5 of the die 1 and thus to the impression 4.

The fall bar 6 and the leg 9, respectively, forms a guiding element for a die 11 being designed as a falling weight. The die 11 is movable with respect to the die 1. For this purpose, the die 11 includes an opening 12 through which the leg 9 of the fall bar 6 fully or partly protrudes. In this way, the leg 11 may be manually lifted, and it falls down when being released. The die 11 is also made of a body having a comparatively great mass, for example a metal ball. The die 11 at its bottom side includes a concave impression 13 such that a nut (not illustrated) being placed upon the center of the impression 4 of the die 1 is hit by the die 11 falling down. In this way, the shell (or the husk or the peel) of the nut is cracked. Due to the association of the impressions 4 and 13 being located at the dies 1 and 11, the nut is automatically placed in the impression 4 in a centric way with respect to the axis 5. The center of the nut is hit by the die 11 acting as a falling weight. At the same time, the impressions 4 and 13 prevent splinters of the nut shell leaving the region of the impression 4.

The user of the apparatus 100 for cracking nuts may realize an exact adjustment of the apparatus 100 by choosing different falling heights during a plurality of falling tests. In this way, the desired result, meaning to crack the shell of the nut without damaging the core, is realized in a reliable way. For simplifying the use of different falling heights, the leg 9 of the fall bar 6 may include different marks 14 relating to different kinds of nuts or simply a scale indicating different falling heights.

The exemplary embodiment of the novel apparatus 100 illustrated in FIG. 1 is illustrated in a certain position of the die 11 with respect to the die 1 during a falling test. It is to be seen in FIG. 1 that the die 11 with its opening 12 being opened towards both sides is captively arranged at the leg 9 of the fall bar 6. However, the design may also be chosen such that the leg 9 of the fall bar 6 ends at a higher level such that the stand 11 may be removed, for example for cleaning purposes. It is preferred to choose the design of the novel apparatus 100 such that the die 11 is still partly guided at the leg 9 of the fall bar 6 when the die 11 hits a nut. Furthermore, it is to be seen in FIG. 1 that the dies 1 and 11 do not necessarily have to be designed to be rotationally symmetric. It is also possible to choose a design which is square as seen in cross-section, or a different design.

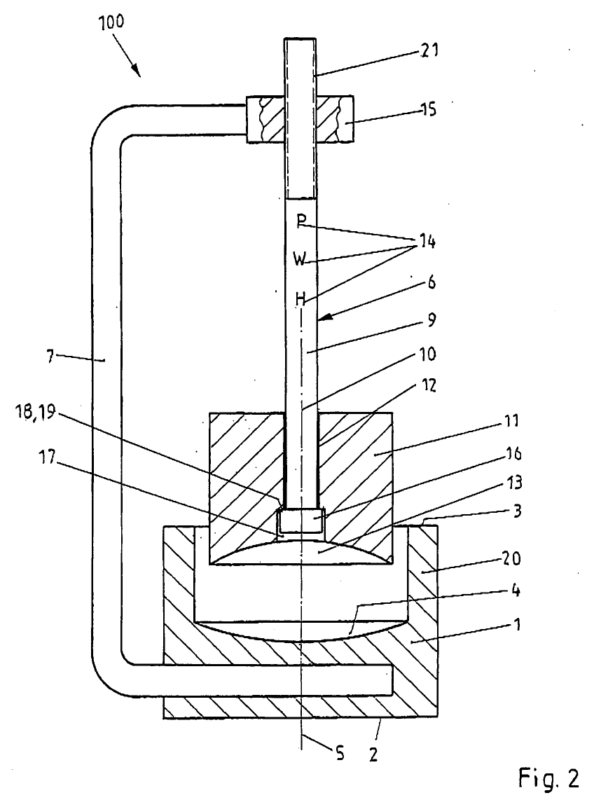

FIG. 2 illustrates another exemplary embodiment of the novel apparatus 100 for cracking a nut. Again, gravity is used by arranging the die 11 to be movable with respect to the vertical leg 9 of the apparatus 100. In this case, the guiding element for the movable die 11 is designed to include a plurality of parts. The leg 7 is fixedly connected to the die 11 serving as the stand of the apparatus 100. The leg 7 at its upper end includes a nut 15 having an inner thread. The leg 9 of the fall bar 6 is designed as a separate bar-like element. The leg 9 in its upper part includes a section having an outer thread 21 rotatably engaging the inner thread of the nut 15. At the other end of the leg 9, and enlarged head 16 is arranged. In association with the head 16, the opening 12 of the die 11 is designed to include steps, and it includes an enlarged portion 17 facing the head 16. The head 16 with its rim protruding in an upward direction forms a stop element 18 being associated with a corresponding annular counter-stop element 19 being located at the movable die 11. In this way, the falling path of the die 11 is limited. By turning the leg 9 of the fall bar 6, the end position of the die 11 may be determined after having conducted a falling test. In this way, there is the possibility of sensitively adjusting the end position in coordination with the diameter of the nut to be cracked and to prevent the core of the nut from being unintentionally damaged. Again, marks 14 being associated with different kinds of nuts, for example hazelnuts H, walnuts W and Brazil nuts P, are provided to indicate different falling heights to be used by the user of the apparatus 100.

As it is to be seen from FIG. 2, the stand and the stationary die 1, respectively, includes a continuous rim 20 protruding in an upward direction. The die 11 at least partly enters the rim 20 when falling down towards a nut. In this way, it is very effectively prevented that splinters of the nut shell leave the apparatus 100 when the nut is cracked.

Especially, the parts and elements of the apparatus 100 are made of metal. Such a design also has the advantage of the apparatus 100 not only fulfilling its purposes with respect to technology, but also with respect to design.

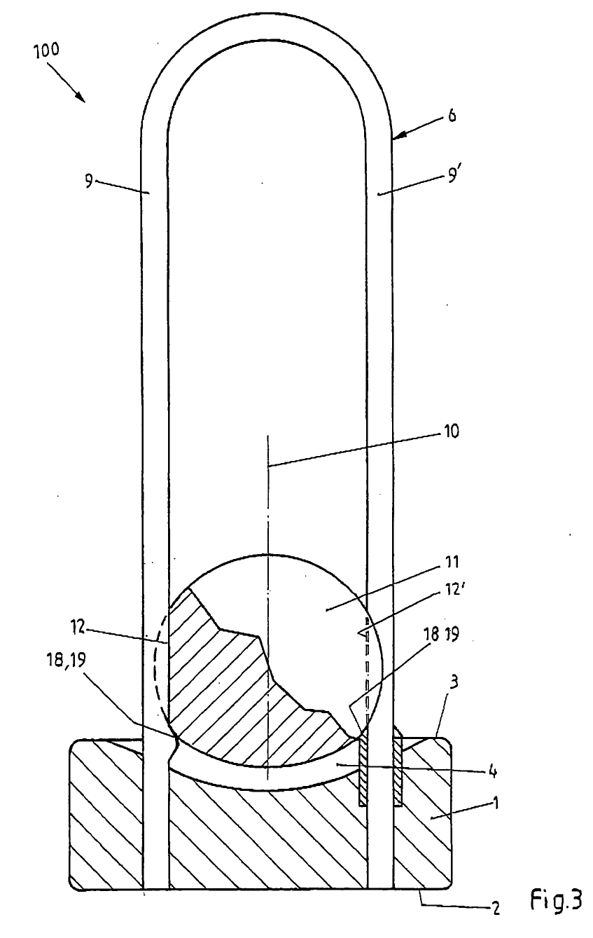

The embodiment of the apparatus 100 illustrated in FIG. 3 includes a U-shaped fall bar 6 at which the movable die 11 is guided. The fall bar 6 includes two legs 9 and 9′ being eccentrically arranged with respect to the axis 10 and of which the lower ends are fixedly connected in the stationary die 1. The movable die 11 includes openings 12 and 12′ being associated with the legs 9 and 9′. In this case, the openings 12 and 12′ are designed as circumferentially open channels. Thus, the falling weight is captively collated between the legs 9 and 9′, and it is securely guided along the entire falling height. The movable die 11 at its side facing the stationary die 1 has a complete convex design. However, it is also possible to combine this embodiment of the apparatus 100 with the impression 13 as illustrated in FIGS. 1 and 2. The advantage of not arranging a hole at the bottom side of the movable die 11 is that its surface close to the axis 10 may be designed to be continuous. The design of the contact surface of the movable die 11 which contacts the nut is not limited.

In the embodiment of the novel apparatus 100 illustrated in FIG. 3, the falling height may also be limited by a stop element 18 and an associated counter-stop element 19. While FIG. 2 illustrates the limitation of the falling height to be adjustable, FIG. 3 illustrates two possibilities of fixed falling height limitations. At the left side, the stop element 18 is realized as an enlarged portion at the leg 9. At the right side, a different embodiment is illustrated in which the stop element 18 is realized in the form of a bush being inserted into the stationary die 1. The corresponding counter-stop 19 is realized by a surface portion of the movable die 11. It is to be understood that it is preferred to only realize one kind of the stop element 18 in one apparatus 100. The two embodiments of the stop element 18 both being illustrated in FIG. 3 only serve to make it clear that there are different ways of realizing this stop element 18.

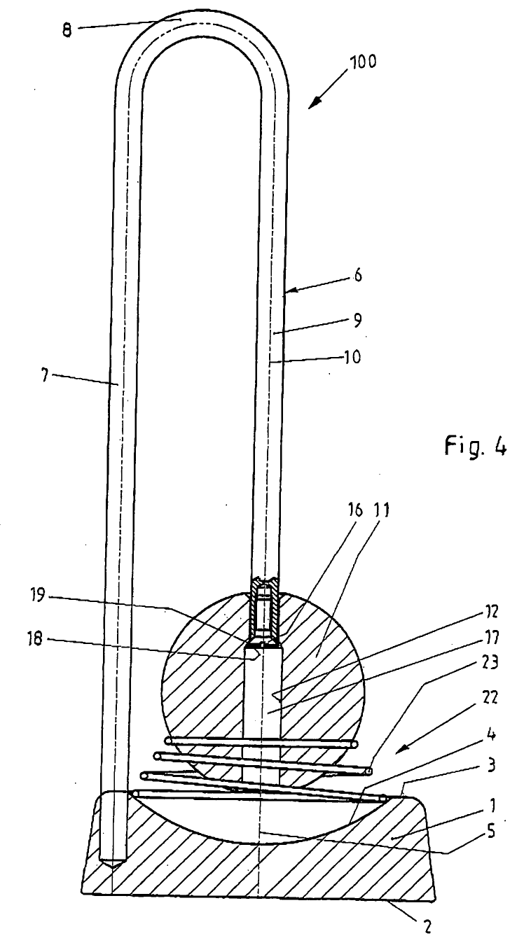

FIG. 4 illustrates another exemplary embodiment of the novel apparatus 100 which is similar to the above described embodiments illustrated in FIGS. 1 to 3. With respect to the corresponding elements, it is referred to the above description. The enlarged head 16 is formed by a screw being screwed in the lower end of the leg 9 of the fall bar 6. The screw forms a conical stop element 18 which cooperates with a respectively designed counter-stop element 19 such that the falling height is limited in this way. The die 11 forming the falling weight is designed as a rotationally symmetric body. It does not include an impression at its bottom side facing the die 1 with the exception of the opening 12 including a chamfered enlarged portion 17.

The apparatus 100 according to FIG. 4 includes a splash guard element 22 being realized by a conical spring 23. The spring 23 may be designed as a detachable element. The impression 4 may include a continuous channel (not illustrated) to centrically arrange the spring 23 in the impression 4. The spring 23 in its released position may have a height which is slightly more than the height illustrated in FIG. 4 such that it is slightly compressed when the die 11 falls down. In this way, the windings of the spring 23 approach, and the effect of the splash guard element 22 is improved. The splash guard element 22 prevents parts of the shell of the nut leaving the impression 4 of the die 1 when the nut is cracked. The spring 23 may be permanently connected to the die 1 or the die 11. It is preferred to connect the spring 23 to the die 11 since this arrangement simplifies removal of the nut and of the parts of the shell from the impression 4 after having lifted the die 11. However, each of the three above described arrangements of the spring 23 is possible.

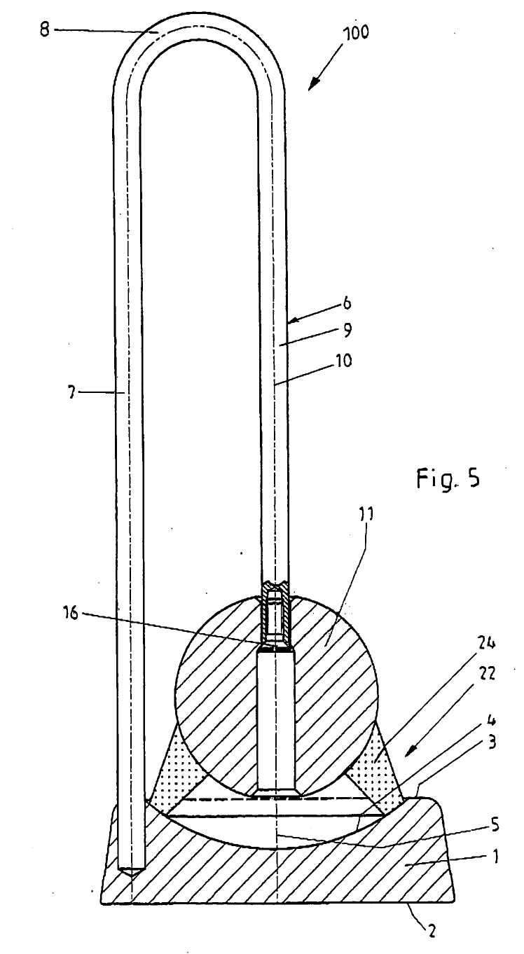

Another exemplary embodiment of the novel apparatus 100 is illustrated in FIG. 5. This exemplary embodiment has some elements in common with the above described embodiments. Thus, it is partly referred to the above description. A form body 24 being made of resilient plastic foam is used as the splash guard element 22. This form body 24 preferably is permanently connected to the die 11. However, different ways of arranging the form body 24 are possible. The form body 24 serving as splash guard element 22 has the advantage of providing a closed wall surrounding the nut similar to the protruding rim 20 of the embodiment of the apparatus 100 illustrated in FIG. 2. A splash guard element 22 may also be arranged at the two dies 1 and 11. For this purpose, one part is located at the die 1 and the other part is located at the die 11. The two dies 1 and 11 with their rims engage one another in a telescopic way when the die 11 contacts the nut.

Many variations and modifications may be made to the preferred embodiments of the invention without departing substantially from the spirit and principles of the invention. All such modifications and variations are intended to be included herein within the scope of the present invention, as defined by the following claims.

I claim:

1. An apparatus for cracking a nut, comprising:
a stationary die; and
a movable die, said movable die being designed as a falling weight, said falling weight being designed and arranged to fall down towards said stationary die due to gravity to crack the nut.

2. The apparatus of claim 1, wherein said falling weight has a mass and is designed and arranged to be placed at a falling height from said stationary die, the mass and the falling height being chosen to crack the nut.

3. The apparatus of claim 1, wherein said movable die is designed and arranged to be guided in a vertical direction.

4. The apparatus of claim 1, further comprising a fall bar, wherein said movable die includes an opening, said fall bar being designed and arranged to protrude through said opening.

5. The apparatus of claim 1, wherein said stationary die has a surface including an impression and said movable die has a surface including an impression, said impressions being arranged to face one another.

6. The apparatus of claim 1, further comprising a fall bar, said fall bar having a inverted U-shaped design and including a first leg and a second leg, said first leg being fixedly connected to said stationary die and said second leg being designed and arranged to protrude through said movable die.

7. The apparatus of claim 6, wherein said stationary die has a surface including an impression, said second leg of said fall bar being designed and arranged to freely end above said impression of said stationary die.

8. The apparatus of claim 1, wherein said stationary die has an approximately spherical shape and a bottom side including an impression.

9. The apparatus of claim 1, further comprising a fall bar, said fall bar including a plurality of marks being associated with different kinds of nuts and different kinds of falling heights.

10. The apparatus of claim 1, further comprising a splash guard element being arranged close to said dies.

11. The apparatus of claim 10, wherein said splash guard element is connected to said movable die.

12. The apparatus of claim 1, wherein said stationary die is designed as a stand having a mass which is greater mass than the mass of said movable die.

13. A nut cracker, comprising:
a stand including an approximately horizontal supporting surface, said supporting surface being designed and arranged to hold a nut;
a fall bar having an approximately vertical axis, said fall bar being connected to said stand; and
a movable cracking element, said movable cracking element being designed and arranged to be movable with respect to said fall bar due to gravity in a way that said movable cracking element falls down towards said supporting surface to crack a nut.

14. The nut cracker of claim 13, wherein said fall bar has an inverted U-shaped design and includes a first approximately vertical leg and a second approximately vertical leg, said first leg being fixedly connected to said stand and said second leg being designed and arranged to protrude through said cracking element and to end above said supporting surface.

15. The nut cracker of claim 14, wherein said second leg of said fall bar includes a plurality of marks being associated with different kinds of nuts and different kinds of falling heights.
